(19) United States
(12) Patent Application Publication
(10) Pub. No.: US 2005/0174728 A1
(43) Pub. Date: Aug. 11, 2005

(54) Notebook having attachable speaker device

(76) Inventor: Tseng Tien Peng, Chong Ho City (TW)

Correspondence Address: Tseng Tien PENG, P.O. Box 10-69, Chong Ho, Taipei, 235, TW

(21) Appl. No.: 10/779,229

(22) Filed: Feb. 11, 2004

(51) Int. Cl. G06F 1/16; H04R 5/02

(52) U.S. Cl. 361/683; 361/681; 381/300; 381/87

(57) ABSTRACT

A notebook computer includes a monitor having a frame, a speaker device having a housing to receive one or more speaker members. The housing includes a casing having a space to receive the frame and to attach the casing and the housing to the frame of the monitor. A securing device may further be used to secure the speaker device to the monitor, for allowing the speaker device to be easily carried with the monitor. The securing device includes one or more fasteners to secure the casing and the housing to the frame of the monitor, or may include an adhesive member to secure the casing to the frame of the monitor.

### BACKGROUND OF THE INVENTION

1. Field of the Invention

The present invention relates to a notebook computer, and more particularly to a notebook computer having a speaker device attachable thereto and detachable therefrom.

2. Description of the Prior Art

Typical notebook computers comprise an inbuilt speaker device provided and engaged therein. However, the inbuilt speaker device normally include a quality that is good enough for generating sounds only, but may not provide stereo or Hi-Fi stereo for users.

Accordingly, an outer or additional speaker device is further required to be provided and coupled to the typical notebook computers for providing better quality of sounds or stereo for the users.

However, the outer or additional speaker devices are normally required to be disposed on top of the computer desks and may thus occupy additional spaces of the computer desks. The computer desks may normally be occupied by computers, printers, monitors, or the other peripheral facilities and may have no spare spaces to support the outer or additional speaker devices.

In addition, when the notebook computers are carried outdoors by the users, there will be no suitable spaces or supporting devices to support the outer or additional speaker devices, and it will be difficult to couple the speaker devices to the notebook computers.

The present invention has arisen to mitigate and/or obviate the afore-described disadvantages of the conventional notebook computers.

### SUMMARY OF THE INVENTION

The primary objective of the present invention is to provide a notebook computer including a speaker device attachable thereto and detachable therefrom.

In accordance with one aspect of the invention, there is provided a notebook computer comprising a monitor including a frame, a speaker device including a housing, at least one speaker member received in the housing, and the housing including a casing having a space formed therein to receive the frame and to attach the casing and the housing to the frame of the monitor, and a securing device for securing the speaker device to the monitor and thus for allowing the speaker device to be easily carried with the monitor.

The securing device includes at least one fastener engaged through the casing and engaged with the frame of the monitor, to secure the casing and the housing to the frame of the monitor. For example, the casing includes two side plates and an upper plate to define the space thereof and to receive the frame, the fastener is engaged through either of the side plates of the casing.

The fastener includes a knob and a threaded shank extended from the knob to engage through either of the side plates of the casing. The knob of the fastener includes a knurled outer surface for facilitating a rotation of the fastener. A gasket may further be provided and engaged onto the threaded shank of the fastener and engaged between the knob and the side plate of the casing.

The fastener includes a follower attached to the threaded shank, to engage with the frame of the monitor. The follower includes a recess formed therein, and a pad engaged in the recess of the follower to engage with the frame of the monitor.

The securing device may include an adhesive member to secure the casing to the frame of the monitor. The adhesive member may be attached to the casing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front perspective view of a notebook computer in accordance with the present invention having speaker devices attached thereto;

FIG. 2 is a rear perspective view of the notebook computer having the speaker devices attached thereto;

FIG. 3 is a front perspective view of the speaker device of the notebook computer;

FIG. 4 is a rear perspective view of the speaker device of the notebook computer;

FIG. 5 is another front perspective view of the speaker device of the notebook computer, as seen from the other angular direction of the notebook computer;

FIG. 6 is a partial exploded view of the speaker device of the notebook computer; and

FIG. 7 is a front perspective view of the notebook computer similar to FIG. 1, illustrating the other arrangement of the notebook computer.

### DETAILED DESCRIPTION OF THE PREFERRED EMBODIMENT

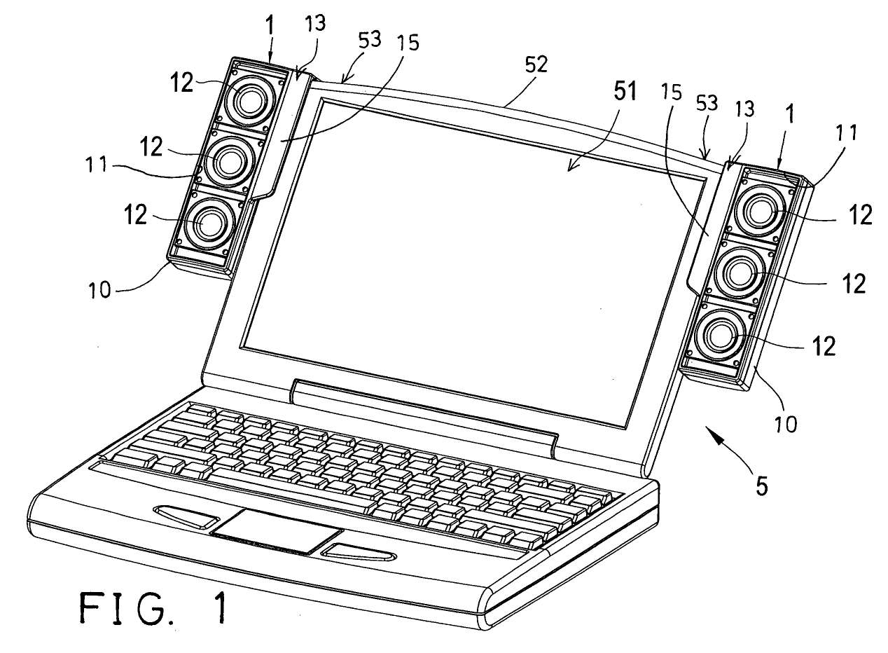

Referring to the drawings, and initially to FIGS. 1-6, a notebook computer in accordance with the present invention comprises a monitor 5 including a screen 51 provided in an outer or peripheral frame 52 which includes two corner areas 53 for attaching one or more speaker devices 1 thereto.

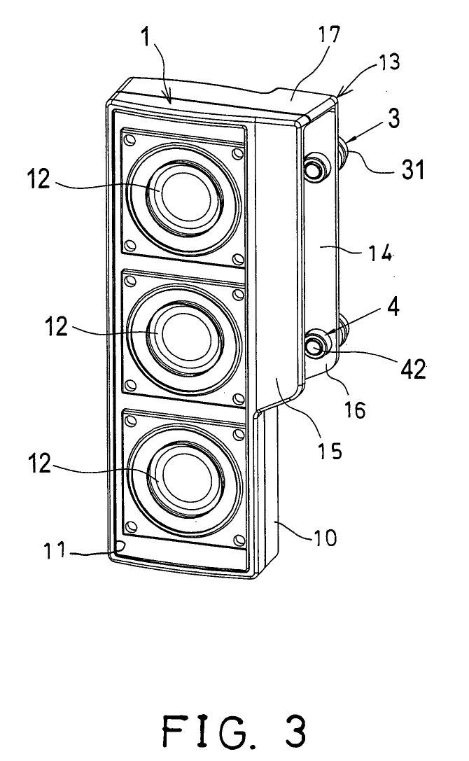

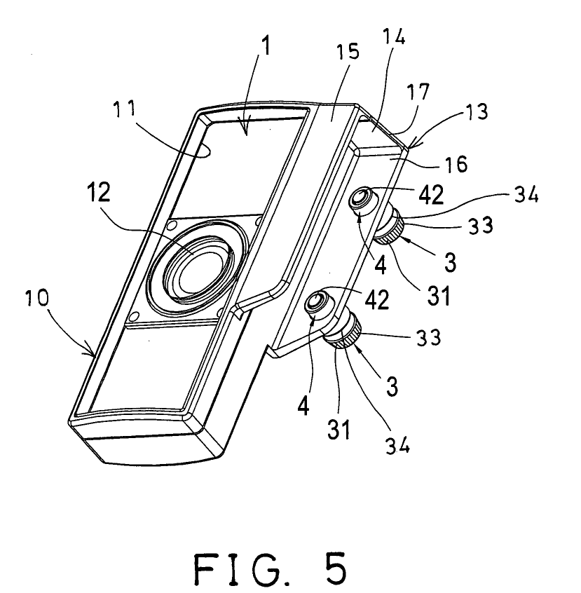

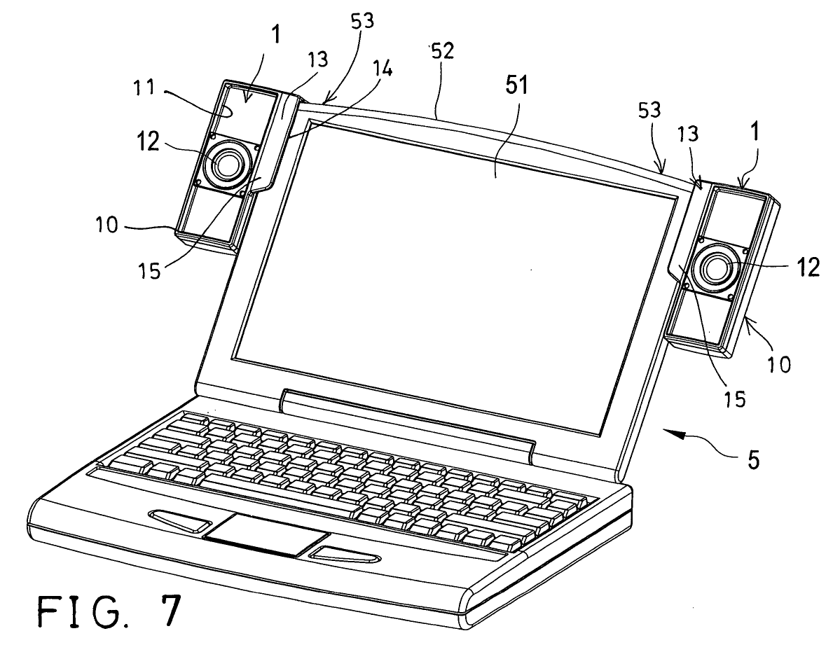

Each of the speaker devices 1 includes a housing 10 having a chamber 11 formed therein for receiving one or more speaker members 12 therein. For example, one (FIGS. 5, 6, 7) or more, such as three speaker members 12 (FIGS. 1, 3) may be disposed and retained in the chamber 11 of the housing 10.

Each of the speaker devices 1 further includes a casing 13 attached to or extended from or provided on the housing 10 and having a space 14 formed therein for receiving either of the corner areas 53 of the peripheral frame 52 of the monitor 5 (FIGS. 1, 2, 7), and thus for attaching the speaker devices 1 onto the monitor 5 of the notebook computer.

For example, each of the casings 13 includes two opposite or side plates 15, 16, and an upper plate 17 to form or define the space 14 thereof, and to stably receive either of the corner areas 53 of the peripheral frame 52 of the monitor 5 therein. The side plates 15, 16 may include suitable resilience to solidly attach or secure the casing 13 and thus the housing 10 of the speaker device 1 to the monitor 5 of the notebook computer with such as force-fitted engagements.

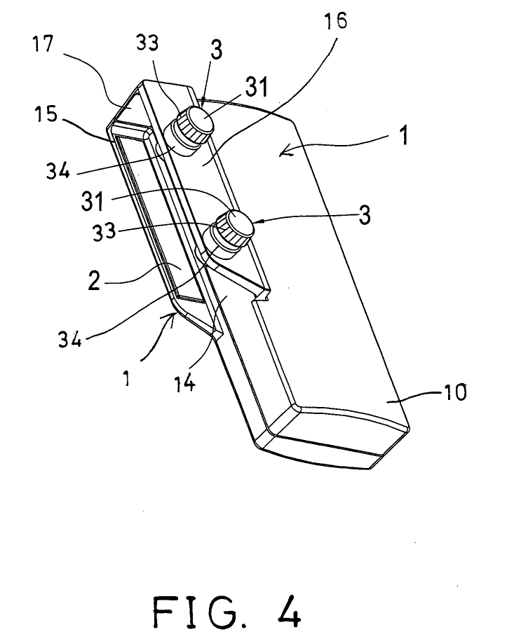

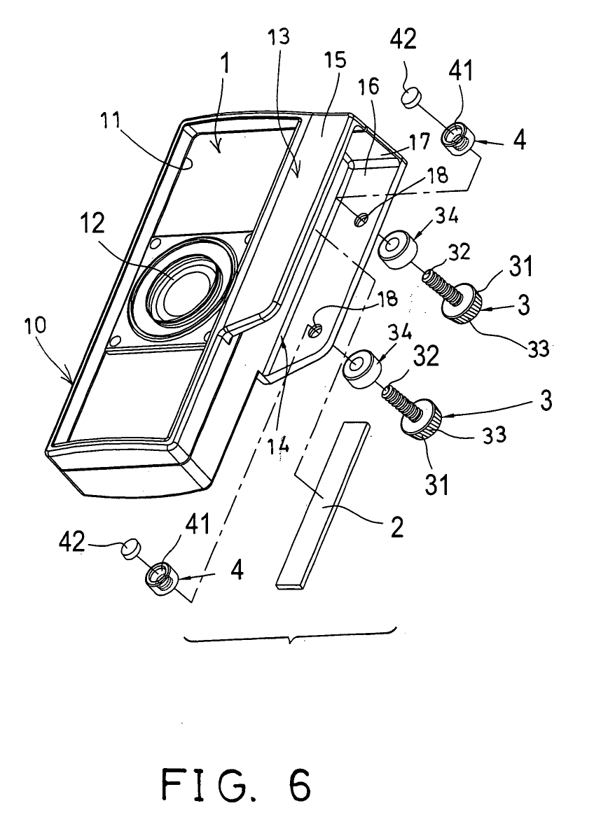

One or more adhesive materials or members 2 may further be provided and attached to either or both of the side plates 15, 16 of the casing 13 (FIGS. 4, 6), to further adhere and secure the casing 13 and thus the housing 10 of the speaker device 1 to the monitor 5 of the notebook computer.

The casing 13 may further include one or more, such as two screw holes 18 formed in either or both of the side plates 15, 16. One or more fasteners 3 may further be provided and each includes a knob 31 and a threaded shank 32 extended therefrom for threading with the screw holes 18 of the casing 13, and for engaging with the monitor 5 of the notebook computer, to further solidly secure the casing 13 and thus the housing 10 of the speaker device 1 to the monitor 5 of the notebook computer.

It is preferable that each of the fasteners 3 includes a knurled surface 33 formed or provided on the knob 31 for allowing the knob 31 to be suitably rotated by the users. A gasket 34 may further be provided and engaged onto the threaded shank 32 of the fastener 3, for engaging between the knob 31 and the side plate 16 of the casing 13, to protect the side plate 16 of the casing 13 from being damaged by the knob 31 of the fastener 3.

A follower 4 may further be provided and engaged or threaded onto the threaded shank 32 of the fastener 3, and may include a recess 41 formed in one end thereof to receive a pad 42 therein (FIG. 6). The pads 42 of the followers 4 may be engaged onto the peripheral frame 52 of the monitor 5, to protect the peripheral frame 52 of the monitor 5 from being damaged by the threaded shank 32 of the fastener 3.

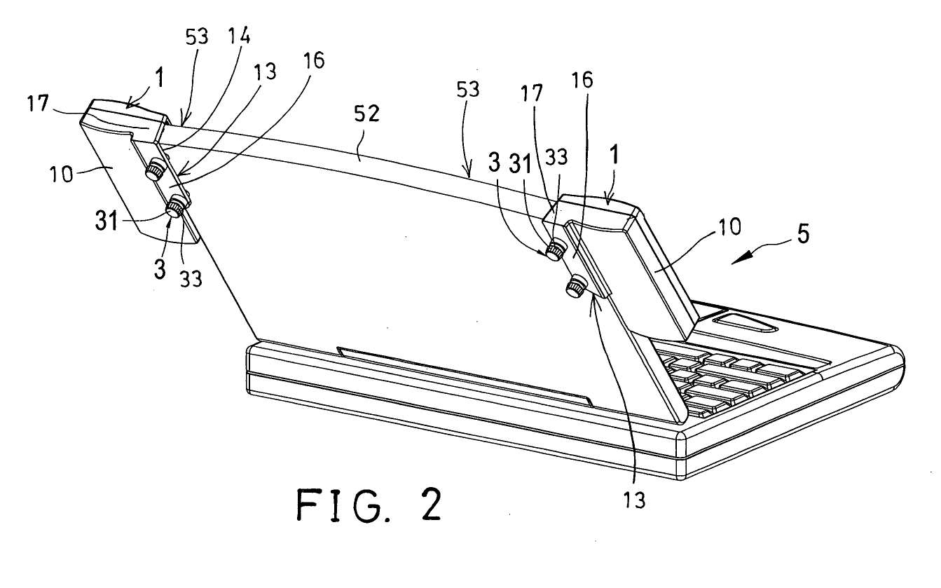

In operation, as shown in FIGS. 1 and 2, one or more speaker devices 1 may be attached onto either of the corner areas 53 of the peripheral frame 52 of the monitor 5 by engaging the corner areas 53 of the peripheral frame 52 of the monitor 5 into the spaces 14 of the casing 13, and/or by the adhesive materials or members 2, and/or by the fasteners 3.

Accordingly, the notebook computer in accordance with the present invention includes a speaker device attachable thereto and detachable therefrom.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A notebook computer comprising:
a monitor including a frame,
a speaker device including a housing, at least one speaker member received in said housing, and said housing including a casing having a space formed therein to receive said frame and to attach said casing and said housing to said frame of said monitor, and
means for securing said speaker device to said monitor.

2. The notebook computer as claimed in claim 1, wherein said securing means includes at least one fastener engaged through said casing and engaged with said frame of said monitor, to secure said casing and said housing to said frame of said monitor.

3. The notebook computer as claimed in claim 2, wherein said casing includes two side plates and an upper plate to define said space thereof and to receive said frame, said at least one fastener is engaged through either of said side plates of said casing.

4. The notebook computer as claimed in claim 2, wherein said at least one fastener includes a knob and a threaded shank extended from said knob to engage through either of said side plates of said casing.

5. The notebook computer as claimed in claim 4, wherein said knob of said at least one fastener includes a knurled outer surface for facilitating a rotation of said at least one fastener.

6. The notebook computer as claimed in claim 4 further comprising a gasket engaged onto said threaded shank of said at least one fastener and engaged between said knob and said side plate of said casing.

7. The notebook computer as claimed in claim 4, wherein said at least one fastener includes a follower attached to said threaded shank, to engage with said frame of said monitor.

8. The notebook computer as claimed in claim 7, wherein said follower includes a recess formed therein, and a pad engaged in said recess of said follower to engage with said frame of said monitor.

9. The notebook computer as claimed in claim 1, wherein said securing means includes an adhesive member to secure said casing to said frame of said monitor.

10. The notebook computer as claimed in claim 9, wherein said adhesive member is attached to said casing.
